(19) United States
(12) Patent Application Publication
(10) Pub. No.: US 2012/0317004 A1
(43) Pub. Date: Dec. 13, 2012

(54) UTILITY BILL AUDIT

(76) Inventors: ROBERT JAMES BURKE, Dallas, TX (US); John Preston Bennett, Sacramento, CA (US); Prateek Sangal, Frisco, TX (US); Jose Alejandro Barahona Echeverria, San Pedro Garza Garcia (MX)

(21) Appl. No.: 13/155,222

(22) Filed: Jun. 7, 2011

(51) Int. Cl. G06Q 40/00; G06Q 50/00

(52) U.S. Cl. 705/34

(57) ABSTRACT

A system, computer-implemented method, and a computer program product are provided for a utility bill audit. Measured data is input from meters. Utility provider information is input. The utility provider information includes utility provider sub-costs and utility provider variables. System data is generated based on the measured data. The system data includes system sub-costs and system variables. If a utility provider sub-cost differs from a corresponding system sub-cost by more than a selected sub-cost error threshold, whether a utility provider variable differs from a corresponding system variable by more than a selected variable error threshold is determined. A user interface outputs a notice regarding whether utility provider information differs from corresponding system data.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE PRESENT DISCLOSURE

The embodiments of the present disclosure relate generally to data verification, and more specifically to a system, computer-implemented method, and computer program product for auditing a utility bill.

### BACKGROUND

Utility providers often use a single source of information to calculate customers' bills. Customers may not have great confidence that a utility bill is correct because the single source of information may be prone to error. For example, human error may occur while manually reading a meter. Furthermore, a properly read meter may be poorly calibrated and/or configured incorrectly. Some meters are only estimated, instead of read, which introduces an additional possibility of an error due to the approximation inherent in the estimation. Yet another type of error may be created when an incorrect method of calculating a utility bill is applied to correctly metered data. In addition to different variables, the introduction of aspects such as time of use, variable billing periods throughout a day, week, month, or season, may make the methods of calculating a utility bill more complex, thereby significantly increasing the probability of an error occurring. The unreliability of the customer's utility bills creates a strong incentive for the customer to verify the utility bill results. However, the effort required for a customer to collect the same metered data that is used by the utility provider to calculate the customer's utility bill and apply the correct method of calculating the utility bill may be both cost and time prohibitive, and prone to the same types of errors. Upon receipt of a utility bill, the customer may have great difficulty in verifying that the utility bill was generated using accurate meter readings and the correct methods of calculations.

### SUMMARY

A system, computer-implemented method, and computer program product are provided for a utility bill audit. When a customer receives a utility bill, the customer can determine if the utility bill includes any potential errors. The customer may use an energy management system to execute a utility bill audit. The energy management system collects measured data, such as from meters, generates system costs using this measured data and equations and information from the utility provider, and compares the system costs to the costs listed in the utility bill. The energy management system compares utility provider sub-costs to calculated system sub-costs to isolate and identify the source and quantity of any potential billing error. Where a system and utility provider sub-cost is identified as differing beyond a selected threshold, the energy management system evaluates the equation coefficients and/or the variables used by the equations to calculate the sub-costs. If the system determines, for example, that the utility provider equations and the system equations use different equation coefficients, the system regenerates the system data using the equations coefficients used by the utility provider for further comparison and analysis. The system may further compare utility provider and system variables. For each variable that differs, the system may output a recommendation to the user, such as to verify the accuracy of the meters that correspond to the variables. In addition to ensuring that the utility bills received are correct, the customer may use the utility bill audit during billing disputes with the utility provider.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure;

FIG. 2 presents a sample frame of a display screen presented by a user interface of the present disclosure;

FIG. 3 presents a sample method of the present disclosure.

### DETAILED DESCRIPTION OF SOME EMBODIMENTS

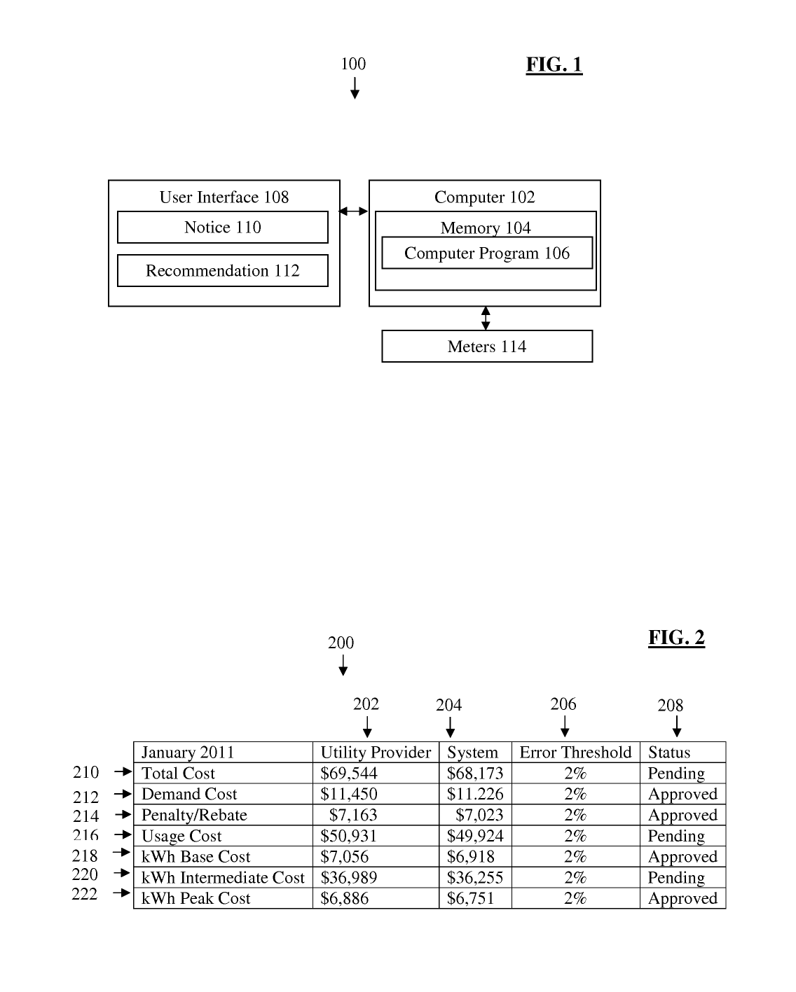

FIG. 1 presents a sample system 100 of the present disclosure, which may also be referred to as an energy management system 100. The system 100 includes a computer 102, a memory 104, a computer program 106, and a user interface 108. The computer program 106 is stored in the memory 104 and executed by the computer 102 to communicate via the user interface 108 with system users, including the sending of the notice 110 and the recommendation 112. The user interface 108 provides access for the system users to the notice 110 and the recommendation 112, where access may be based on acceptance of access-enabling information, such as user identifications and passwords, input via the user interface 108.

The computer 102 receives measured data from meters 114. The meters 114 may be the utility provider's meters, the customer's meters, or any combination thereof. The meters 114 may be any combination of sub-meters, shadow meters, and virtual meters that emulate a utility meter by summing all the measured data from the sub-meters. Although FIG. 1 depicts one of each of the elements 102-114, the system 100 may include any number of each of the elements 102-114.

Measured data is input from the meters 114 to the energy management system 100. This measured data serves as the basis for data generated by the energy management system 100 to compare to the utility provider information.

As soon as a customer receives a utility bill, the customer can determine if the utility bill includes any potential cost errors. Utility provider information may be input from a utility bill and/or other utility provider sources in any of a variety of ways. For example, if a utility bill is provided as a hard copy, a system user may scan the hard copy of the utility bill to create a soft copy of the utility bill, and extract utility provider information from the soft copy of the utility bill. In another example, if the utility bill is provided as a soft copy document, such as a portable document file (pdf), the system user may extract utility provider information from the soft copy document of the utility bill. In a further example, the system user may also access a portal to retrieve a soft copy of the utility bill and extract utility provider information from the soft copy of the utility bill. In an additional example, the system user may retrieve a spreadsheet of the utility bill and extract utility provider information from the spreadsheet of the utility bill.

The utility provider information is a collection of costs, sub-costs, and equations composed of coefficients and variables used to generate the costs and sub-costs. Utility provider information may include information not appearing on a bill, but retrieved from or located on another source, such as a provider contract, data sheet, website or other posting or notice. A variable may be measured data input from a meter or derived from measured data input from a meter.

Once the utility bill is received, the energy management system 100 may generate system data based on the measured data received from the meters 114 over the same time period identified by the utility bill. The system data may include a configured bill decomposition tree which defines the relationship between the costs, sub-costs, and the equations with their variables and coefficients used to generate the costs and sub-costs, and the calculated results of the equations. The energy management system 100 may decompose utility provider information, such as found on a bill or other provider source, recursively into a decomposition tree of costs and sub-costs. This decomposition may continue until the sub-costs are broken down to their constituent equations. These equations may be finally broken down into their respective variables and coefficients. Then the system 100 may recursively move through the decomposition tree, comparing the relevant values at each level such as cost, sub-costs, equations, equation coefficients, and/or equation variables against the values used by the utility provider and selected error thresholds.

A notice may be generated for each level in the decomposition tree that summarizes the respective calculated values compared to the actual values in the utility provider information and their respective system thresholds. The level of decomposition and the relevant thresholds may be configured within the system 100. In addition, the decomposition tree may define a relevant error threshold for each cost, sub-cost, equation, coefficient, and variable that will be audited. The decomposition tree may be configured to match exactly a utility provider's structure, including system cost, system sub-costs, system coefficients, and system variables, where each of the system's data corresponds to utility provider information from the utility bill or information used to generate the utility bill, such as tariff rates. After the energy management system 100 generates the system data corresponding to the utility provider information, the system 100 may audit the utility bill by making individual comparisons between system data and corresponding utility provider information.

If the energy management system 100 determines that the utility provider total cost is within a specified error threshold of the system total cost, the system 100 outputs a notice 110 via the user interface 108, indicating that the utility bill has been audited and approved. This example depicts the quickest type of a utility bill audit. A system user may set the specified threshold to an acceptable value. For example, if a system user sets the total cost error threshold at 2%, the utility provider information includes a total cost of $69,536, and the energy management system 100 calculated the total cost as $68,173, the customer may be satisfied that the utility bill is acceptable within the selected 2% threshold of the system total cost.

The selected error threshold is preferably set as a percentage difference from the utility provider information. However, a threshold can be selected as absolute unit difference, such as dollars, kilowatts, numerical units, etc., depending on the utility provider information being compared, or as a combination of such units and percentage differences.

If the utility provider cost is not within the selected threshold of the system cost, the energy management system 100 may determine whether each of the utility provider sub-costs are within a selected threshold of their corresponding system sub-costs. For example, a utility bill may include sub-costs such as a usage cost, a demand cost, and a penalty cost. An example of a frame of a notice 110 that includes these costs is described below in reference to FIG. 2.

For each utility provider sub-cost within the selected threshold of their corresponding system sub-cost, the system 100 outputs a notice 110 indicating that the utility provider sub-cost has been audited and approved. Although the selected threshold for each sub-cost may be the same, in a preferred embodiment, a system user has the option of setting a different error threshold value for each sub-cost, such as cost difference, percentage variance, or a combination of each. The system continues the audit process for each utility provider sub-cost that is not within the selected threshold of its corresponding system sub-cost. In this manner, the energy management system 100 isolates the potential sources of discrepancies between the utility provider information and the corresponding system data. The system 100 thereby isolates and identifies the source and quantity of any potential billing error.

Then the energy management system 100 ensures that the utility bill audit uses the correct equation coefficients and variables to calculate the identified sub-costs.

For each utility provider sub-cost that is not within the selected threshold of its corresponding system sub-cost, the energy management system 100 identifies whether the coefficients used by the utility provider to generate the sub-cost are within a selected threshold of the coefficients used by the system to calculate the corresponding sub-cost. Equation coefficients can be a function of a number of parameters such as time-of-use, location, date, and utility provider. Although the selected threshold for each factor may be the same, a system user has the option of setting a different threshold for each coefficient.

Note that in some situations, a coefficient (or other) threshold may be set to zero, which would result in the processing and notification to the user of any difference between a utility provider coefficient and the corresponding system coefficient. For example, the system 100 may use a coefficient of $0.12 per kilowatt hour in an equation, based on this coefficient being used in the previous month's utility bill, but the current month's utility bill may use $0.13 per kilowatt hour due to a rate increase. If set at a zero threshold, even such a small difference will be recognized and the user alerted to the difference. In other embodiments, the system 100 processes all differences, but provides notices only for differences not within their selected threshold.

Examples of other coefficients that may be used in equations to calculate utility provider sub-costs include billable demand price, energy cost, demand cost, kilowatt-hour price for a base time of use, kilowatt-hour price for an intermediate time of use, kilowatt-hour price for sub-peak time of use, and kilowatt-hour price for a peak time of use.

The system 100 may output a notice 110 to the user where the difference between a utility provider coefficient and system coefficient is not within the selected threshold. Additionally, the system 100 may output a notice 110 where the utility provider coefficient is within the selected coefficient threshold of its corresponding system coefficient to indicate that the coefficients are within acceptable limits.

The energy management system 100 uses any utility provider coefficient that differs from its corresponding system coefficient by more than the selected coefficient threshold to recalculate or regenerate the sub-costs associated with the differing coefficient. At this point in the audit process, the energy management system 100 compares the regenerated costs and/or regenerated sub-costs to the utility provider costs and sub-costs to determine if the substitution of the identified coefficient(s) in the equation(s) corrected the identified difference(s) between the utility provider information and the system's regenerated data.

If the energy management system 100 continues to detect differences that are determined to be unacceptable between the costs and sub-costs of the utility provider information and the system data, or the system regenerated data, the audit process evaluates the variables used by the equations to produce the utility provider information and the system data, or the system regenerated data.

The energy management system 100 may determine whether each utility provider variable differs from its corresponding system variable by a selected threshold for each sub-cost being evaluated. Although the variable thresholds may be the same for each variable, in a preferred embodiment, a system user has the option of setting a different variable threshold for each variable. For example, for a given equation, the utility provider uses 592 kilowatts as the demand, while the system 100 uses 586 kilowatts; the difference is less than a selected 2% threshold.

Examples of other variables used in generating the utility provider total cost include kilovolt-ampere reactive (kVAr), kilovolt-ampere reactive hours (kVArh), power factor, kilowatts during a base time of use, kilowatts during an intermediate time of use, kilowatts during a sub-peak time of use, kilowatts during a peak time of use, kilowatt hours during a base time of use, kilowatt hours during an intermediate time of use, kilowatt-hours during a sub-peak time of use, and kilowatt hours during a peak time of use.

A preferred embodiment of the system will also compare values composed of combined coefficients and variables. An example of a coefficient combined with a variable is billable demand.

For each utility provider variable within the selected threshold of its corresponding system variable, the system 100 may output a notice indicating that the utility provider variable has been audited and approved. The system 100 outputs a recommendation 112 that the corresponding meters be verified for accuracy where a variable is determined to differ unacceptably. The variable differences may be due to errors based on physical deployment of the meters 114, and/or the process by which the metered data is aggregated. The recommendation may be to verify a current transformer installation, to verify calibration and configuration of a meter or multiple meters, to verify a monthly load profile, and/or to evaluate variable values during base times, intermediate times, sub-peak times, and peak times for time of use calculations. In addition to ensuring that the utility bills received are correct, the customer may use the utility bill audit during billing disputes with the utility provider.

As described above with respect to equation coefficients, the system, where differences are identified between utility provider and system variables, recalculates or regenerates costs and sub-costs to determine if substitution of identified variable(s) in the equation(s) corrected any identified difference(s) between utility provider information and system regenerated data.

Although this disclosure describes examples of an electrical utility, the utility bill audit may be applied to other types of utilities that are metered, such as water, natural gas, and sewage.

Although the audit example described above verifies equation coefficients before verifying variables, the utility bill audit process may occur in different orders, such as verifying variables before verifying equation coefficients. Similarly, the system 100 may compare utility provider and system equations for any differences. Further, the system 100 may compare utility provider and system decomposition trees. Finally, a system 100 may compare a subset of the values compared in the preferred embodiment described above.

FIG. 2 presents a sample frame 200 of a display screen presented by the user interface 108 in FIG. 1 of the present disclosure. The frame 200 includes a utility provider column 202, a system column 204, an error threshold column 206, a status column 208, a total cost row 210, a demand cost row 212, a penalty/rebate row 214, a usage cost row 216, a kWh base cost row 218, a kWh intermediate cost row 220, and a kWh peak cost row 222. The utility provider column 202 includes utility provider information in the rows 210-222, such as taken from, for example, an electrical utility bill. The system column 204 includes system data in the rows 210-222 that depict the corresponding sub-costs and the total cost calculated by the energy management system 100 in FIG. 1. The error threshold column 206 includes the error thresholds in the rows 210-222 that correspond to the differences between the sub-costs and the total cost from the electrical utility bill and the corresponding sub-costs and the total cost calculated by the energy management system 100 in FIG. 1. The status column 208 includes the audit status in the rows 210-222 that correspond to the sub-costs and the total cost from the electrical utility bill. In this example, the total cost row 210 lists pending instead of approved in the status column 208 because the utility provider's total cost of $69,544 exceeds the system's total cost of $68,173 by more than the error threshold of 2% selected for the total cost. Sub-costs for the total cost are then evaluated because these total costs differ by more than the total cost error threshold. Continuing this example, the usage cost row 216 lists pending instead of approved in the status column 208 because the utility provider's usage cost of $50,931 exceeds the system's usage cost of $49,924 by more than the error threshold of 2% selected for the usage cost. Sub-costs for the usage cost are then evaluated because these usage costs differ by more than the usage cost error threshold. Further to this example, the kWh intermediate cost row 220 lists pending instead of approved in the status column 208 because the utility provider's kWh intermediate cost of $36,989 exceeds the system's kWh intermediate cost of $36,255 by more than the error threshold of 2% selected for the kWh intermediate cost.

The frame 200 may be part of a larger display screen that includes fields for users to enter search criteria, such as searches based on periods of time, total costs, sub-costs, equation coefficients, and variables. The user interface 108 in FIG. 1 may output a display screen that includes the frame 200 in response to a search based on search criteria input via the user interface 108 in FIG. 1. For example, a system user may request to view all of the utility provider information for the most recent calendar year along with the corresponding data generated by the energy management system 100 in FIG. 1.

Because the frame 200 is a sample, the frame 200 could vary greatly in appearance. For example, the relative sizes and positioning of the columns and rows is not important to the practice of the present disclosure. The frame 200 can be depicted by any visual display, but are preferably depicted by a computer screen. The frame could also be output as a report and printed or saved in electronic format, such as a portable document file. The frame 200 can be part of a personal computer system and/or a network, and operated from system data received locally, by the network, and/or on the Internet. The frame 200 may be navigable by a user. Typically, the user can employ a touch screen input or a mouse input device to point-and-click to a location on the frame 200 to manage the utility provider information and system data on the frame 200, such as the selection of fields or icons that enable reviewing details for the utility provider information and the system data. Alternately, the user can employ directional indicators, or other input devices such as a keyboard. The utility provider information and system data depicted by the frame 200 is an example, as the frame 200 may have a much larger number of rows and/or columns. Note that although the text as shown is located in some parts of the frame 200, in another embodiment the text could be located in other parts of the frame 200. The frame 200 may also include fields in which the user can input textual information, such as notes on responses from the electrical utility company regarding adjustments to the total cost for a month based on errors identified by the data generated by the energy management system 100 in FIG. 1.

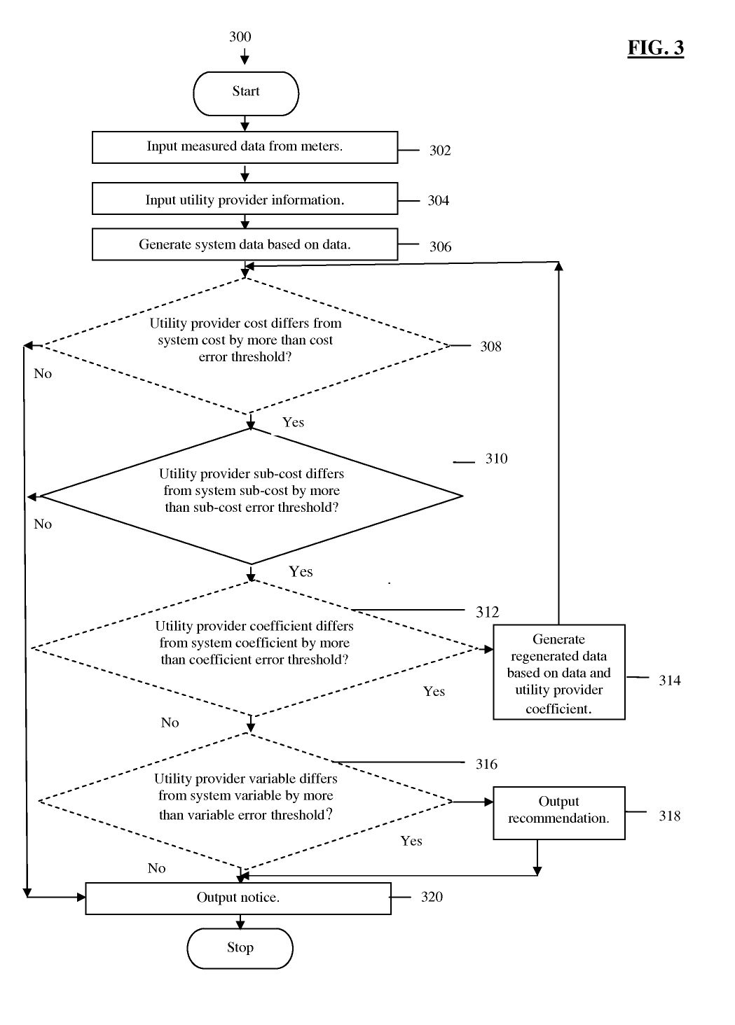

FIG. 3 presents a sample method 300 of the present disclosure. The energy management system 100 in FIG. 1 may execute the method 300 to audit a utility bill.

In box 302, measured data is input from meters. For example, the computer program 106 requests and receives measured data from the meters 114.

In box 304, utility provider information is input from a utility provider. For example, the computer program 106 inputs the January 2011 utility provider information, including the utility provider information depicted in the utility provider column 202 in FIG. 2.

In box 306, system data is generated based on the measured data. For example, the computer program 106 generates the system data, including the system data depicted in the system column 204 in FIG. 2, based on the measured data from the meters 114.

In box 308, a determination is optionally made whether a utility provider cost differs from a system cost by more than a cost error threshold. For example, the computer program 106 determines whether the utility bill total cost of $69,544 differs from the system's total cost of $68,173 by more than the total cost error threshold of 2%. Box 308 is optional because method 300 may proceed directly from box 306 to box 310 to verify sub-costs without first verifying the total cost. If the utility provider cost differs from the system cost by more than the cost error threshold, the method 300 continues to box 310 to determine which sub-cost(s) are responsible for the unacceptable error. If the utility provider cost does not differ from the system cost by more than the cost error threshold, the method 300 proceeds to box 320 to output a notice that the utility bill has been audited and approved.

In box 310, a determination is made whether a utility provider sub-cost differs from a system sub-cost by more than a sub-cost error threshold. For example, the computer program 106 determines whether the utility provider demand cost of $11,450 differs from the system demand cost of $11,217 by more than the sub-cost error threshold of 2%. Although the example of the sub-cost error threshold offered for box 310 and the example of the cost error threshold offered for box 308 are both 2%, the user may specify different error thresholds for the cost error threshold and each sub-cost error threshold. For each utility provider sub-cost that differs from its corresponding system sub-cost by more than the selected sub-cost error threshold, the method 300 continues to box 312 to identify at least one source for the significant difference. For each utility provider sub-cost that does not differ from its corresponding system sub-cost by more than the selected sub-cost error threshold, the method 300 proceeds to box 320 to output a notice that specifies that the corresponding utility provider sub-cost has been audited and approved.

In box 312, a determination is made whether a utility provider coefficient differs from a system coefficient by more than a coefficient error threshold. For example, the computer program 106 determines whether the utility provider coefficient of $0.13 per kilowatt hours differs from the system coefficient of $0.12 per kilowatt hours by more than the coefficient error threshold of 5%. Although this example describes a coefficient error threshold of 5%, a user of the system 100 may select to set any coefficient error threshold to 0%, such that any difference between a utility provider coefficient and a corresponding system coefficient will result in a regeneration of system data. If a utility provider coefficient differs from its corresponding system coefficient by more than the selected coefficient error threshold, the method 300 continues to box 314 to recalculate the previously calculated system costs and sub-costs. If a utility provider coefficient does not differ from its corresponding system coefficient by more than the selected coefficient error threshold, the method 300 proceeds to box 316 to determine if a variable error was responsible for a corresponding sub-cost difference.

In box 314, regenerated system data is generated based on the measured data and the utility provider coefficient. For example, the computer program 106 generates regenerated system data based on the measured data and the utility provider coefficient of $0.13 per kilowatt hours that was identified as differing from its corresponding system coefficient of $0.12 per kilowatt hours by more than the selected coefficient error threshold of 5%. The method 300 returns to box 308 to compare the regenerated system total cost against the utility provider total cost. If the substitution of the correct coefficient resulted in a regenerated system total cost within the specified error percentage of the utility provider total cost, the method 300 may then proceed to box 320 to output a notice that identifies the substituted utility provider coefficient and specifies that the utility bill has been audited and approved.

In box 316, a determination is made whether a utility provider variable differs from a system variable by more than a variable error threshold. For example, the computer program 106 determines whether the utility provider variable of 175,058 kilowatt hours differs from the system variable of 169,959 kilowatt hours by more than the variable error threshold of 2%. For each utility provider variable that differs from the system variable by more than the variable error threshold, the method 300 continues to box 318 to output a recommendation for verifying the readings from the meters 114 associated with the identified variable. For each utility provider variable that does not differ from the system variable by more than the variable error threshold, the method 300 proceeds to box 320 to output a notice that specifies that the corresponding utility provider variable has been audited and approved.

In box 318, a recommendation is output. For example, the computer program 106 outputs a recommendation to recalibrate the meters 114 that were responsible for the system kilowatt hours of 169,959, which differed from the utility provider's 175,058 kilowatt hours by more than the selected 2% variable error threshold. Then method 300 continues to box 320 to output a notice about variable differences.

In box 320, a notice is output. For example, the computer program 106 outputs a notice that specifies that the utility bill has been audited, and specifies any discrepancies between costs, sub-costs, coefficients, and variables that the method 300 has identified. The method 300 may be repeated as desired. Although this disclosure describes the boxes 302-320 executing in a particular order, the boxes 302-320 may be executed in a different order, such as when variables are verified before equation coefficients are verified.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

1. A computer program product for a utility bill audit, the computer program product including:
a computer readable storage medium storing computer executable program code that, when executed by a processor, causes the computer executable program code to perform a method including the steps of:
inputting measured data from a plurality of meters;
inputting utility provider information including a utility provider cost, a plurality of utility provider sub-costs, a plurality of utility provider coefficients, and a plurality of utility provider variables;
calculating system data based on the measured data, wherein the system data includes a system cost, a plurality of system sub-costs, a plurality of system coefficients, and a plurality of system variables;
determining whether the utility provider cost differs from the system cost by more than a cost error threshold;
determining whether a utility provider sub-cost differs from a corresponding system sub-cost by more than a selected sub-cost error threshold in response to a determination that the utility provider cost differs from the system cost by more than the cost error threshold;
determining whether a utility provider coefficient differs from a corresponding system coefficient by more than a selected coefficient error threshold in response to a determination that the utility provider sub-cost differs from the corresponding system sub-cost by more than the selected sub-cost error threshold;
recalculating system data based on the measured data and the utility provider coefficient in response to a determination that the utility provider coefficient differs from the corresponding system coefficient by more than the selected coefficient error threshold, wherein the regenerated system data includes a regenerated system cost, a plurality of regenerated system sub-costs, a subset of the system coefficients, and the plurality of system variables;
determining whether the utility provider cost differs from the regenerated system cost by more than the cost error threshold;
determining whether the utility provider sub-cost differs from a corresponding regenerated system sub-cost by more than the selected sub-cost error threshold in response to a determination that the utility provider cost differs from the regenerated system cost by more than the cost error threshold;
determining whether a utility provider variable differs from a corresponding system variable by more than a selected variable error threshold in response to a determination that the utility provider sub-cost differs from the corresponding regenerated system sub-cost by more than the selected sub-cost error threshold; and
outputting, via the user interface, a notice regarding whether utility provider information differs from corresponding system data.

2. A computer program product as in claim 1, wherein at least one of the utility provider sub-costs includes one of a penalty and a rebate.

3. A computer program product as in claim 1, wherein a system coefficient combined with a system variable includes a billable demand.

4. A computer-implemented method for a utility bill audit, the method including the steps of:
inputting, to a computer program stored in a memory and executed by a computer, measured data from a plurality of meters;
inputting, to the computer program, utility provider information that includes a plurality of utility provider sub-costs and a plurality of utility provider coefficients;
generating, by the computer program, system data based on the measured data, wherein the system data includes a plurality of system sub-costs and a plurality of system coefficients;
determining, by the computer program, whether a utility provider sub-cost differs from a corresponding system sub-cost by more than a selected sub-cost error threshold; determining, by the computer program, whether a utility provider coefficient differs from a corresponding system coefficient by more than a selected coefficient error threshold in response to a determination that the utility provider sub-cost differs from the corresponding system sub-cost by more than the selected sub-cost error threshold;
regenerating, by the computer program, system data based on the measured data and the utility provider coefficient determined to differ from the corresponding system coefficient, wherein the regenerated system data includes a plurality of regenerated system sub-costs;
determining, by the computer program, whether the utility provider sub-cost differs from a corresponding regenerated system sub-cost by more than a selected sub-cost error threshold; and
outputting, by the computer program via a user interface, a notice regarding whether utility provider information differs from corresponding regenerated system data.

5. A computer-implemented method as in claim 4, wherein at least one of the utility provider coefficients and the corresponding system coefficients includes one of kilowatt-hour price, billable demand price, energy cost, and demand cost.

6. A computer-implemented method as in claim 4, further including outputting, by the computer program via the user interface, a notice that specifies whether the utility provider coefficient differs from the corresponding system coefficient by more than the selected coefficient error.

7. A computer-implemented method as in claim 4, wherein inputting the utility provider information includes scanning a hard copy of a utility bill to create a soft copy of the utility bill and extracting the utility provider information from the soft copy of the utility bill.

8. A computer-implemented method as in claim 4, wherein inputting the utility provider information includes receiving a soft copy document of a utility bill and extracting the utility provider information from the soft copy document of the utility bill.

9. A computer-implemented method as in claim 4, wherein inputting the utility provider information includes accessing a portal to retrieve a soft copy of the utility bill and extracting the utility provider information from the soft copy of the utility bill.

10. A computer-implemented method as in claim 4, wherein inputting the utility provider information includes retrieving a spreadsheet of the utility bill and extracting the utility provider information from the spreadsheet of the utility bill.

11. A system for a utility bill audit, the system including:
a computer;
a memory;
a user interface; and
a computer program stored in the memory and executable by the computer to:
input measured data from a plurality of meters,
input utility provider information including a plurality of utility provider sub-costs and a plurality of utility provider variables,
generate system data based on the measured data, wherein the system data includes a plurality of system sub-costs and a plurality of system variables,
determine whether a utility provider sub-cost differs from a corresponding system sub-cost by more than a selected sub-cost error threshold,
determine whether a utility provider variable differs from a corresponding system variable by more than a selected variable error threshold, and
output, via the user interface, a notice regarding whether utility provider information differs from corresponding system data.

12. A system as in claim 11, wherein the utility provider information further includes a utility provider equation and the system data further includes a corresponding system equation, the computer program executable to determine whether the utility provider equation differs from the corresponding system equation.

13. A system as in claim 10, wherein the utility provider information further includes a plurality of utility provider coefficients, wherein the system data further includes a plurality of corresponding system coefficients, and
wherein the computer program is further executable to: determine whether a utility provider coefficient differs from a corresponding system coefficient by more than a selected coefficient error threshold.

14. A system as in claim 13, wherein the computer program is executable to determine whether a utility provider coefficient differs from a corresponding system coefficient in response to a prior determination that a utility provider sub-cost differs from a system sub-cost.

15. A system as in claim 14, wherein the computer program is further executable to output, via the user interface, a notice regarding whether any utility provider coefficient differs from a corresponding system coefficient.

16. A system as in claim 10, wherein the computer program is executable to determine whether a utility provider variable differs from a corresponding system variable in response to a prior determination that a utility provider sub-cost differs from a corresponding system sub-cost.

17. A system as in claim 10, wherein the notice identifies which utility provider information differs from its corresponding system data and by how much.

18. A system as in claim 10, wherein the system data further includes a decomposition tree.

19. A system as in claim 10, wherein at least one of the utility provider variables and the corresponding system variables is measured by one of kilowatt-hours, kilowatts, kilovolt-ampere reactive, kilovolt-ampere reactive hours, and power factor.

20. A system as in claim 10, wherein the computer program further outputs a recommendation to evaluate variable values during at least one of base times, intermediate times, sub-peak times, and peak times.
